(19) United States
(12) Patent Application Publication
(10) Pub. No.: US 2025/0256706 A1
(43) Pub. Date: Aug. 14, 2025

(54) METHOD FOR CONTROLLING A DRIVER ASSISTANCE FUNCTION OF A MOTOR VEHICLE, CONTROL UNIT AND MOTOR VEHICLE

(71) Applicant: Volkswagen Aktiengesellschaft, Wolfsburg (DE)

(72) Inventors: Arne Bartels, Wolfsburg (DE); Stefan Milch, Hemkenrode (DE); Timo Klingemann, Sassenburg (DE)

(21) Appl. No.: 19/043,449

(22) Filed: Feb. 1, 2025

(30) Foreign Application Priority Data
Feb. 8, 2024 (DE) 102024201143.6

(51) Int. Cl. B60W 30/09; B60W 10/18; B60W 30/095; B60W 30/14; B60W 30/18; B60W 50/12

(52) U.S. Cl. CPC B60W 30/09; B60W 10/18; B60W 30/0956; B60W 30/146; B60W 30/18145; B60W 30/18159; B60W 50/12; B60W 2520/10; B60W 2555/20; B60W 2556/10

(57) ABSTRACT

A system, method, and control unit for controlling a driver assistance function of a motor vehicle are provided. The driver assistance function assists a driver during a turning maneuver. An action of the driver assistance function is suppressed when the motor vehicle's speed exceeds a predefined speed limiting value and is permitted when the speed is at or below the predefined speed limiting value. The speed limiting value is dynamically adjusted based on an ascertained outside temperature. A first value is selected as the speed limiting value when the outside temperature is greater than or equal to a predefined temperature limit value, and a second, lower value is selected when the outside temperature is below the predefined temperature limit value.

### RELATED APPLICATIONS

The present application claims priority to German Patent Application No. 102024201143.6, filed Feb. 8, 2024, the contents of which is incorporated by reference in its entirety herein.

### TECHNICAL FIELD

The present disclosure relates to a method for controlling a driver assistance function of a motor vehicle, as well as to a control unit and a motor vehicle configured to implement the method.

### BACKGROUND

A method for actuating an adaptive cornering assistance system of a vehicle is described in DE 10 2016 003 026 A1. In this method, a curve is detected in advance, and upon detection, the cornering assistance system determines a maximum allowable speed for the vehicle to safely navigate the curve. This maximum speed is then compared to the vehicle's current speed. If the current speed exceeds the calculated maximum speed, an intervention is triggered to reduce the speed. Additionally, the method pre-evaluates weather conditions in the vicinity of the detected curve to refine the determination of the maximum speed.

The present disclosure provides a solution to assist a driver in operating a motor vehicle in a manner that enhances road safety and maneuverability through a driver assistance function.

### SUMMARY

According to some aspects of the present disclosure, the described functionality is achieved by the independent claims of the present application, as detailed below. Additional aspects are disclosed in the dependent claims, the description, and the drawings. Features, advantages, and possible implementations described in connection with one subject of the independent claims should be understood as applicable, at least analogously, to other independent claims, as well as any combination of independent and dependent claims.

In some examples, a method is disclosed for controlling a driver assistance function of a motor vehicle, such as an automobile or a passenger car. The driver assistance function is configured to assist a driver of the motor vehicle during a turning maneuver. In particular, the driver assistance function is designed to assist the driver when executing a turn that involves crossing an opposing traffic lane, such as a left turn in right-hand traffic regions or a right turn in left-hand traffic regions.

In some examples, a control unit is disclosed that is configured to control a driver assistance function in accordance with the disclosed method. Specifically, the control unit is configured to suppress the activation of the driver assistance function if the motor vehicle's speed exceeds a predefined speed limiting value. Conversely, the control unit is configured to allow activation of the driver assistance function if the motor vehicle's speed is at or below the predefined speed limiting value. The control unit is further configured to determine the speed limiting value based on an ascertained outside temperature. A first value is selected when the outside temperature is greater than or equal to a predefined temperature limit value, while a second, lower value is selected when the outside temperature is below the predefined temperature limit value.

In some examples, a motor vehicle is disclosed that includes a control unit configured as described in connection with the present disclosure.

Additional features of the present disclosure can be derived from the following description and the accompanying drawings. The features and combinations of features described above, as well as those shown in the drawings, can be used individually or in various combinations without departing from the scope of the present disclosure.

### BRIEF DESCRIPTION OF THE DRAWINGS

FIG. 1 shows a schematic diagram of a method sequence for controlling a driver assistance function of a motor vehicle, according to some aspects of the present disclosure; and

FIG. 2 shows a schematic top view of a traffic situation in which the motor vehicle is controlled by means of an action of the driver assistance function, according to some aspects of the present disclosure.

### DETAILED DESCRIPTION

In some examples, an action of the driver assistance function is suppressed when the motor vehicle has a speed above a predefined speed limiting value. The suppression of the action of the driver assistance function is lifted when the motor vehicle has a speed that is equal to or below the predefined speed limiting value. Thus, if the motor vehicle is traveling at a speed equal to or below the predefined speed limiting value, the driver assistance function provides assistance in controlling the motor vehicle. However, if the motor vehicle exceeds the predefined speed limiting value, the driver assistance function does not provide assistance. As a result, the driver assistance function operates only at lower speeds at or below the predefined speed limiting value. This limitation is based on safety considerations, as intervening in the driver's control at high speeds may be unsafe. In particular, the action performed by the driver assistance function may involve automatic longitudinal and/or lateral control of the motor vehicle.

In some examples, the predefined speed limiting value is dynamically adjusted based on the outside temperature. Specifically, a first value is selected as the speed limiting value when the ascertained outside temperature is greater than or equal to a predefined temperature limit value. A second value, which is lower than the first value, is selected as the speed limiting value when the ascertained outside temperature is below the predefined temperature limit value. In other words, as the outside temperature decreases, the speed range in which the driver assistance function remains active is reduced. When the outside temperature falls below the predefined temperature limit value, it is assumed that road conditions, such as ice or packed snow, result in a lower friction coefficient for the vehicle's tires, thereby increasing the stopping distance. To ensure safe operation under such conditions, the speed limiting value is reduced from the first value to the second value. If the ascertained outside temperature meets or exceeds the predefined temperature limit value, it is assumed that the likelihood of ice or snow on the roadway is low, allowing the motor vehicle to maintain sufficient traction at speeds up to the first value. As a result, the suppression of the driver assistance function is lifted for a broader speed range extending from zero kilometers per hour to the first value.

The method enables the determination of whether the driver assistance function should be suppressed due to high vehicle speeds or whether it should remain active at lower speeds, incorporating weather conditions as an influencing factor. By considering outside temperature as an indicator of road friction, the method allows for a rapid determination regarding whether to suppress the driver assistance function, utilizing minimal sensor data.

In some examples, the predefined temperature limit value is set to four degrees Celsius. Below this temperature, greater caution is exercised to account for potentially slippery road conditions. If an outside temperature below four degrees Celsius is detected, it is assumed that there is an increased risk of ice or packed snow. Conversely, when the temperature is at or above four degrees Celsius, the likelihood of ice or packed snow is significantly lower. By setting the temperature limit value to four degrees Celsius, the method accounts for potential winter road hazards, ensuring that the vehicle's speed limiting value is appropriately adjusted for safe operation.

In some examples, the first speed limiting value is set to 30 kilometers per hour, while the second speed limiting value is set to 20 kilometers per hour. Accordingly, when the outside temperature is greater than or equal to the predefined temperature limit value, the driver assistance function is suppressed only when the motor vehicle's speed exceeds 30 kilometers per hour. However, when the outside temperature is below the predefined temperature limit value, the driver assistance function is suppressed at speeds above 20 kilometers per hour.

These speed limits are selected based on the operational characteristics of a front assist system, which serves as a driver assistance function by engaging automatic braking when a potential collision with oncoming traffic is detected during a turn. The front assist system, also referred to as a turning assistance function, can intervene by applying full braking force if a collision is imminent. This intervention is typically implemented at speeds of no more than 20 kilometers per hour to ensure that the vehicle can come to a complete stop within its own lane after braking. Otherwise, a collision with oncoming traffic may occur.

The predefined speed limiting value is determined based on a calculated stopping distance, which accounts for an estimated friction coefficient between the road surface and the vehicle's tires. The calculation assumes an average friction coefficient of μ=0.5. If information indicating a friction coefficient higher than μ=0.5 is available, the predefined speed limiting value may be increased above the first value, potentially enhancing the effectiveness of the front assist system in turning scenarios. By raising the speed limit, more accidents during turning maneuvers could potentially be prevented.

If the motor vehicle's speed exceeds the predefined speed limiting value, the driver assistance function does not intervene, meaning the vehicle continues through the turn without system intervention. As a result, by the time of a potential collision, the vehicle may have already moved beyond the path of oncoming traffic, reducing the likelihood of a front or side impact and thereby lowering the risk of occupant injuries.

In some examples, the outside temperature is determined based on a temperature measurement value obtained from a temperature sensor and an ascertained driving situation. The temperature measurement value may be adjusted based on the driving situation to account for environmental influences that could cause deviations from the actual outside temperature. For example, if the motor vehicle has been stationary for an extended period, heat buildup near the temperature sensor may result in a temperature measurement that is higher than the actual outside temperature. Similarly, if the motor vehicle is located in an enclosed space, such as a garage, the detected temperature may not accurately reflect ambient outdoor conditions. By adjusting the temperature measurement value based on the driving situation, the outside temperature can be determined with improved accuracy.

In some examples, the temperature sensor used to obtain the temperature measurement value is a negative temperature coefficient (NTC) resistor. This type of sensor is particularly robust and enables highly reliable temperature measurement. NTC resistors, also referred to as thermistors, exhibit a decrease in electrical resistance as temperature increases. The temperature measurement value can be determined by measuring the electrical current passing through the resistor, providing an efficient and accurate method for detecting temperature variations.

In some examples, the driving situation is determined based on at least one of multiple factors. One such factor is the speed profile of the motor vehicle over a specified period. By analyzing the motor vehicle's recent speed history, it can be determined whether the motor vehicle was previously stationary or traveling at a low speed, conditions that may lead to heat buildup near the temperature sensor. Another factor involves the characteristics of the driving route previously traveled by the motor vehicle. For instance, if the motor vehicle recently exited a garage or a parking facility, the detected temperature may be higher than the actual outside temperature. Additionally, the duration of vehicle operation may be considered, as the elapsed time since the motor vehicle began moving can provide insight into the extent of heat buildup affecting the temperature sensor's reading.

The accuracy of the ascertained driving situation is improved when multiple factors are considered in combination. By incorporating multiple sources of information, the adjustment of the temperature measurement value can be optimized to better reflect actual ambient conditions.

In some examples, the driving situation is determined using data obtained from surroundings sensors and/or odometry data. The surroundings sensor may include a camera, radar, LIDAR, or ultrasonic sensors configured to detect environmental conditions around the motor vehicle. Odometry data, which estimates the motor vehicle's position and movement based on wheel rotation, may also be used. By incorporating surroundings sensor data and odometry data, the driving situation can be determined with high reliability and precision.

In some examples, the action of the driver assistance function involves automatically decelerating the motor vehicle. In particular, the function may execute full braking to prevent a collision with oncoming traffic during a turn. The system is configured to stop the motor vehicle while it remains within its own lane, thereby minimizing the risk of a collision. As a result, the method facilitates a reduction in collision risk during turning maneuvers.

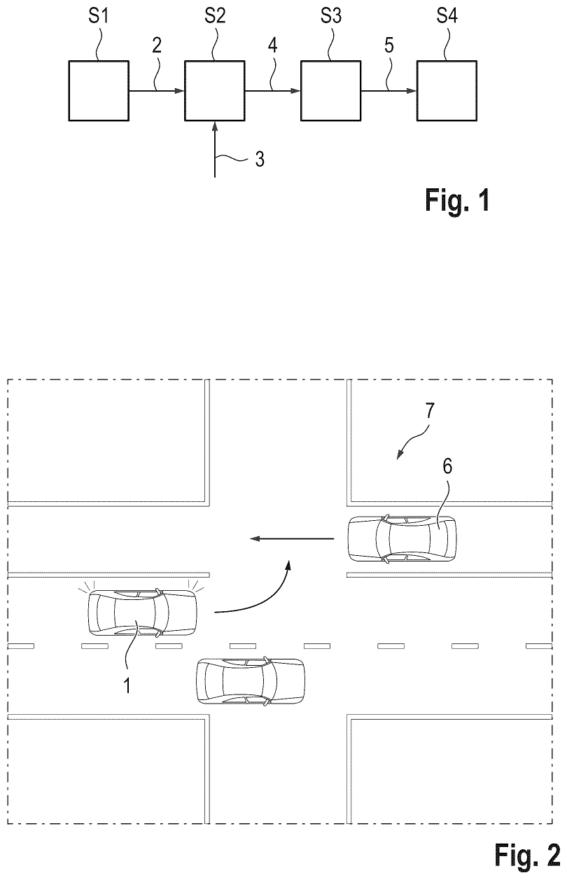

FIG. 1 illustrates a method sequence for controlling a driver assistance function of a motor vehicle 1. The driver assistance function is configured to assist a driver of the motor vehicle 1 during a turning process, such as the one depicted in FIG. 2. The method operates by suppressing an action of the driver assistance function when the motor vehicle's speed exceeds a predefined speed limiting value 5. Conversely, when the motor vehicle's speed is at or below the predefined speed limiting value 5, suppression of the action is lifted. The speed limiting value 5 is dynamically adjusted based on the outside temperature 4. Specifically, a first value is selected as the speed limiting value 5 when the outside temperature 4 is greater than or equal to a predefined temperature limit value. If the outside temperature 4 is below the predefined temperature limit value, a second, lower value is selected as the speed limiting value 5. In the present example, the predefined temperature limit value is set to four degrees Celsius. The first value of the speed limiting range is set to 30 kilometers per hour, while the second value is set to 20 kilometers per hour.

As shown in FIG. 1, the method begins with step S1, in which a temperature measurement value 2 is obtained from a temperature sensor. In this example, the sensor is implemented as a negative temperature coefficient (NTC) resistor. The temperature measurement value 2 is transmitted to evaluation software for processing. The evaluation software also receives driving situation data 3, which provides contextual information about the motor vehicle's operating conditions.

In step S2, the evaluation software analyzes the received temperature measurement value 2 in combination with the driving situation data 3 to determine an ascertained outside temperature 4. The outside temperature 4 is thus derived as a function of both the measured temperature value and the assessed driving situation. The driving situation may be determined based on surroundings sensor data, odometry data, the speed profile of the motor vehicle 1, the characteristics of the recently traveled route, or the duration of motor vehicle operation since start-up.

In step S3, the speed limiting value 5 is established based on the ascertained outside temperature 4. If the outside temperature 4 is at or above the predefined temperature limit value, the first value is assigned as the speed limiting value 5. If the outside temperature 4 is below the predefined temperature limit value, the second, lower value is assigned.

In step S4, the determined speed limiting value 5 is used to evaluate whether the driver assistance function should be suppressed. If the motor vehicle's speed exceeds the predefined speed limiting value 5, the driver assistance function is suppressed, preventing system intervention. If the motor vehicle's speed is at or below the predefined speed limiting value 5, suppression of the action is lifted, allowing the driver assistance function to provide support. In the present example, the driver assistance function executes an automatic braking process, specifically an automatic full brake application.

The outside temperature 4 is determined using a temperature sensor, which in this example is a negative temperature coefficient resistor. The temperature measurement value 2 is inferred from current and voltage readings at the resistor. The measurement data is then transmitted to the evaluation software, where it is processed alongside additional data sources, including driving route history, elapsed driving time, current speed, surroundings data, and odometry data. The evaluation software then transmits the ascertained outside temperature 4 to software responsible for determining the maximum intervention speed, which corresponds to the predefined speed limiting value 5.

If the outside temperature 4 falls below the predefined temperature limit value, the second value is set as the predefined speed limiting value 5 and transmitted to the front assist function software. If the outside temperature 4 is equal to or above the predefined temperature limit value, the first value is set as the predefined speed limiting value 5 and transmitted to the front assist function software.

FIG. 2 illustrates a left-turn maneuver of the motor vehicle 1 at an intersection 7. The driver assistance function assesses the risk of a collision between the motor vehicle 1 and oncoming traffic 6. Based on this assessment, an automatic full brake application may be either triggered or suppressed, depending on whether the current speed of the motor vehicle 1 is at or below, or above, the predefined speed limiting value 5.

The method also considers the stopping distance of the motor vehicle 1, which depends on the friction coefficient between the driving surface and the vehicle's tires. The predefined speed limiting value is determined in consideration of this friction coefficient to ensure that the vehicle can come to a complete stop within its own lane, rather than entering oncoming traffic 6.

Different methods exist for estimating the friction coefficient, each with strengths and weaknesses in terms of availability and accuracy. To achieve a reliable friction coefficient estimation, multiple methods are often combined, resulting in increased system complexity. High system complexity can be particularly disadvantageous for safety-critical functions, such as a front assist or a turning assistance function, and may also lead to increased system costs.

At high speeds, ice and snow on the roadway typically result in friction coefficients between 0.1 and 0.3. When the roadway is wet, the friction coefficient generally falls within a range of 0.5 to 0.8, depending on the level of surface moisture. Experimental braking tests conducted in a simulated rain environment have demonstrated that at 30 kilometers per hour, even under heavy rainfall conditions, the friction coefficient remains well above 0.8. This finding suggests that hydroplaning effects are significantly reduced at lower speeds, allowing the tires to maintain good contact with the road surface. Consequently, wet road conditions have a minimal impact on the friction coefficient at low speeds.

At lower speeds, the primary factors contributing to a reduced friction coefficient are the presence of ice and snow. To increase the predefined speed limiting value 5 for the turning assistance system, it is sufficient to determine whether ice or snow is present on the roadway. Accordingly, for friction coefficient estimation at low speeds, only the temperature sensor is used to ascertain the outside temperature 4.

When the outside temperature 4 drops below a preset threshold, particularly the temperature threshold of four degrees Celsius, the potential presence of ice or snow is assumed. Under such conditions, the predefined speed limiting value of the turning assistance function is set to the second value of 20 kilometers per hour. Conversely, if the outside temperature 4 exceeds this threshold, it is assumed that the road is free of ice and snow, leading to a friction coefficient consistently above 0.8. Under these conditions, the predefined speed limiting value 5 is set to the first value, specifically 30 kilometers per hour.

If the friction coefficient at low speeds can be reliably estimated using only a temperature sensor, this approach significantly reduces system complexity compared to alternative friction estimation methods. The resulting reduction in complexity leads to lower costs and improved system robustness, particularly in safety-critical applications such as the turning assistance function.

Overall, the present disclosure demonstrates how a reliable friction coefficient estimation method can be implemented at low speeds for a turning assistance function, ensuring improved road safety and system efficiency.

### LIST OF REFERENCE SIGNS

1 motor vehicle
2 temperature measurement value
3 driving situation data
4 outside temperature
5 predefined speed limiting value
6 oncoming traffic
7 intersection
S1 to S4 respective method steps

1. A method for controlling a driver assistance function of a motor vehicle, the driver assistance function configured to assist a driver of the motor vehicle during a turning process, the method comprising:
suppressing an action of the driver assistance function when the motor vehicle has a speed above a predefined speed limiting value;
lifting the suppression of the action of the driver assistance function when the motor vehicle has a speed that is at or below the predefined speed limiting value;
selecting a first value as the predefined speed limiting value when an ascertained outside temperature is greater than or equal to a predefined temperature limit value; and
selecting a second value, smaller than the first value, as the predefined speed limiting value when the ascertained outside temperature is smaller than the predefined temperature limit value.

2. The method of claim 1, further comprising predefining the predefined temperature limit value as 4° C.

3. The method of claim 1, further comprising setting the first value to 30 kilometers per hour and setting the second value to 20 kilometers per hour.

4. The method of claim 1, further comprising determining the ascertained outside temperature based on a temperature measurement value obtained from a temperature sensor and a determined driving situation.

5. The method of claim 4, further comprising receiving the temperature measurement value from a temperature sensor comprising a negative temperature coefficient resistor.

6. The method of claim 4, further comprising determining the driving situation based on at least one of:
analyzing a speed profile of the motor vehicle over a period of time;
evaluating characteristics of a driving route previously traveled by the motor vehicle; and
measuring a time duration elapsed since the motor vehicle began moving.

7. The method of claim 6, further comprising determining the driving situation based on at least one of surroundings sensor data and odometry data.

8. The method of claim 1, further comprising automatically decelerating the motor vehicle in response to the driver assistance function being activated.

9. A control unit for controlling a driver assistance function of a motor vehicle, the driver assistance function configured to assist a driver of the motor vehicle during a turning process, the control unit comprising:
a processor;
a memory coupled to the processor; and
a sensor interface coupled to the processor and configured to receive sensor data associated with at least an outside temperature and a vehicle speed,
wherein the processor is configured to:
suppress an action of the driver assistance function when the motor vehicle has a speed above a predefined speed limiting value;
lift the suppression of the action of the driver assistance function when the motor vehicle has a speed that is at or below the predefined speed limiting value;
select a first value as the predefined speed limiting value when an ascertained outside temperature is greater than or equal to a predefined temperature limit value; and
select a second value, smaller than the first value, as the predefined speed limiting value when the ascertained outside temperature is smaller than the predefined temperature limit value.

10. The control unit of claim 9, wherein the processor is configured to define the predefined temperature limit value as 4° C.

11. The control unit of claim 10, wherein the processor is configured to set the first value to 30 kilometers per hour and set the second value to 20 kilometers per hour.

12. The control unit of claim 9, further comprising a temperature sensor coupled to the sensor interface, wherein the processor is configured to determine the ascertained outside temperature based on a temperature measurement value obtained from the temperature sensor and a determined driving situation.

13. The control unit of claim 12, wherein the temperature sensor comprises a negative temperature coefficient resistor.

14. The control unit of claim 12, wherein the processor is configured to determine the driving situation based on at least one of:
analyzing a speed profile of the motor vehicle over a period of time;
evaluating characteristics of a driving route previously traveled by the motor vehicle; and
measuring a time duration elapsed since the motor vehicle began moving.

15. The control unit of claim 14, wherein the processor is configured to determine the driving situation based on at least one of surroundings sensor data and odometry data.

16. The control unit of claim 9, further comprising a braking system coupled to the processor, wherein the processor is configured to automatically decelerate the motor vehicle in response to activation of the driver assistance function.

17. A motor vehicle, comprising:
a control unit according to claim 9;
a braking system coupled to the control unit;
a temperature sensor configured to provide a temperature measurement value to the control unit; and
a speed sensor configured to provide a speed measurement value to the control unit,
wherein the control unit is configured to:
suppress an action of the driver assistance function when the speed measurement value indicates that the motor vehicle has a speed above a predefined speed limiting value;
lift the suppression of the action of the driver assistance function when the speed measurement value indicates that the motor vehicle has a speed that is at or below the predefined speed limiting value;
select a first value as the predefined speed limiting value when the temperature measurement value indicates that an ascertained outside temperature is greater than or equal to a predefined temperature limit value; and
select a second value, smaller than the first value, as the predefined speed limiting value when the temperature measurement value indicates that the ascertained outside temperature is smaller than the predefined temperature limit value.

18. The motor vehicle of claim 17, wherein the control unit is configured to define the predefined temperature limit value as 4° C.

19. The motor vehicle of claim 17, wherein the control unit is configured to set the first value to 30 kilometers per hour and set the second value to 20 kilometers per hour.

20. The motor vehicle of claim 17, wherein the temperature sensor comprises a negative temperature coefficient resistor.
